(19) United States
(12) Patent Application Publication
(10) Pub. No.: US 2026/0119253 A1
(43) Pub. Date: Apr. 30, 2026

(54) METHOD, APPARATUS AND SYSTEM FOR CACHE-BASED WORKLOAD MIGRATION IN A MULTI-CLUSTER ENVIRONMENT

(71) Applicant: FOUNDATION OF SOONGSIL UNIVERSITY INDUSTRY COOPERATION, Seoul (KR)

(72) Inventors: Young Han KIM, Seoul (KR); Mu Seong KWON, Seoul (KR)

(73) Assignee: FOUNDATION OF SOONGSIL UNIVERSITY INDUSTRY COOPERATION, Seoul (KR)

(21) Appl. No.: 19/365,703

(22) Filed: Oct. 22, 2025

(30) Foreign Application Priority Data
Oct. 28, 2024 (KR) 10-2024-0148149
Nov. 15, 2024 (KR) 10-2024-0163396

(51) Int. Cl. G06F 9/50

(52) U.S. Cl. CPC G06F 9/5027

(57) ABSTRACT

A cache-based workload migration method, apparatus, and system in a multi-cluster environment. A cache-based workload migration system in a multi-cluster environment comprises a plurality of member clusters operating workloads and a management cluster built on a control plane in a cloud, configured to deploy workloads to the plurality of member clusters and, when a failure occurs in a first workload of a first member cluster, to perform a first-stage restoration by reading a checkpoint of the first workload backed up in a cache member node of a second member cluster through a migration operator, and to perform a second-stage restoration by retrieving a latest backup file of the first workload stored in an external storage while ensuring gradual inflow of transactions through a transaction queue.

### TECHNICAL FIELD

The present invention relates to a cache-based workload method, apparatus, and system in a multi-cluster environment.

### BACKGROUND ART

Kubernetes is an open-source container orchestration platform that automates many of the manual processes involved in deploying, managing, and scaling containerized applications.

In a Kubernetes-based multi-cluster environment, workload migration issues can arise in various situations. For example, when a sudden surge in traffic or resource exhaustion occurs in one cluster, the workloads in that cluster may fail to be processed properly, leading to service outages.

Such failures can affect not only specific services but also other interconnected services, resulting in overall performance degradation. In the case of stateful workloads executed based on the context of previous transactions—where current transactions are affected by situations that occurred in earlier transactions—simple workload migration cannot easily resolve these issues.

Here, a transaction refers to a unit or sequence of operations that performs a single logical function that changes the state of a database.

Because stateful workloads must maintain data consistency and consider network configurations and complex connection dependencies, the migration methods used for stateless workloads—which do not store information or references to past transactions—cannot be used.

Conventional techniques have mainly focused on restoring stateless workloads, which can shorten service recovery time but fail to adequately address data loss and network complexity problems that occur with stateful workloads.

Therefore, a method has been proposed to periodically store backup files of stateful workloads in external storage and to restore them when a failure occurs. However, such methods often lacked consideration of restoration time and did not take workload migration performance during the restoration process into account. As a result, delays in restoration time or data consistency issues could occur, limiting their ability to prevent real-time service interruptions.

To solve these problems, when a failure occurs in a stateful workload, it should be migrated swiftly to another cluster while maintaining data integrity and minimizing restoration time. Moreover, a mechanism is required to ensure service continuity even during the restoration process.

When service failures occur due to traffic surges or resource exhaustion, various papers have proposed failure recovery mechanisms for both stateless and stateful workloads in single- or multi-cluster environments.

Conventional methods generate checkpoint files for workloads, store them together with Kubernetes resources, and then restore the workload state using the checkpoint and backup files.

A checkpoint is an image or snapshot of a running container or individual application.

However, traditional methods have focused on restoration performance and lacked specific consideration of restoration speed. In particular, real-time preservation and restoration of workload states during failures were limited.

Some papers attempted to address these problems by combining checkpoint methods with resource backup files, but the restoration speed still remained slow. For example, in the case of stateful workloads such as databases, maintaining data consistency during restoration is critical. Existing studies had the problem that, due to the lengthy restoration procedures of such workloads, it was difficult to prevent service interruptions during real-time restoration. In addition, conventional approaches mainly relied on a single restoration method and did not consider rapid service recovery through multi-stage restoration.

### DISCLOSURE

### Technical Problem

To solve the problems of the prior art described above, the present invention proposes a cache-based workload migration method, apparatus, and system in a multi-cluster environment, which enables rapid restoration to another cluster in preparation for performance degradation caused by network failures or resource shortages that may occur while operating microservices in one cluster within a multi-cluster environment.

### Technical Solution

According to one embodiment of the present invention, a cache-based workload migration system in a multi-cluster environment comprises a plurality of member clusters operating workloads and a management cluster built on a control plane in a cloud, configured to deploy workloads to the plurality of member clusters and, when a failure occurs in a first workload of a first member cluster, to perform a first-stage restoration by reading a checkpoint of the first workload backed up in a cache member node of a second member cluster through a migration operator, and to perform a second-stage restoration by retrieving a latest backup file of the first workload stored in an external storage while ensuring gradual inflow of transactions through a transaction queue.

The cache-based workload migration system may further comprise a scheduler configured to perform redeployment scheduling for a failure of the first workload at a cluster level; a workload backup controller configured to back up resources in the plurality of member clusters to an external storage in a Kubernetes environment; and a workload restore controller configured to restore resources in the plurality of member clusters to an original state or to a new cluster by using backed-up data in the Kubernetes environment.

The migration operator may automate workload migration tasks between clusters and ensure data consistency and service continuity.

When a failure occurs in the first workload, the migration operator may generate a cache restore CR (Custom Resource) based on a predefined CRD (Custom Resource Definition), and the workload restore controller may detect the cache restore CR and periodically access a cache member node of the second member cluster to read a checkpoint of the first workload and perform a first-stage restoration.

The migration operator may perform a second-stage restoration by generating a restore CR when detecting “Ready” in a progress state specification of the cache restore CR.

Upon detecting the restore CR, the workload restore controller may read periodically backed-up files from the external storage to perform a second-stage restoration.

After completion of the second-stage restoration, transactions stored in the transaction queue may be sequentially processed.

The failure may include a network failure or performance degradation caused by lack of resources, and may comprise either a cluster-level failure or a workload-level failure within the cluster.

According to another embodiment of the present invention, a cache-based workload migration apparatus in a multi-cluster environment comprises a scheduler configured to manage the state of a plurality of member clusters operating workloads and to perform workload scheduling at a cluster level; a migration operator configured, when a failure occurs in a first workload of a first member cluster among the plurality of member clusters, to perform a first-stage restoration by reading a checkpoint of the first workload backed up in a cache member node of a second member cluster, and to perform a second-stage restoration by retrieving a latest backup file of the first workload stored in an external storage while ensuring gradual inflow of transactions through a transaction queue; a workload backup controller configured to back up resources in the plurality of member clusters to an external storage in a Kubernetes environment; and a workload restore controller configured to restore resources in the plurality of member clusters to an original state or to a new cluster by using the backed-up data in the Kubernetes environment.

According to yet another embodiment of the present invention, a cache-based workload migration method in a multi-cluster environment through a management cluster built on a control plane in a cloud comprises deploying workloads to the plurality of member clusters; performing, when a failure occurs in a first workload of a first member cluster among the plurality of member clusters, a first-stage restoration by reading a checkpoint of the first workload backed up in a cache member node of a second member cluster; and performing a second-stage restoration by retrieving a latest backup file of the first workload stored in an external storage while ensuring gradual inflow of transactions through a transaction queue.

### Advantageous Effects

According to the present invention, workload migration operations, which were previously limited to a single cluster, can be efficiently performed even in a multi-cluster environment.

In addition, according to the present invention, when a system failure occurs, the cache-based rapid first-stage restoration minimizes service downtime, while the second-stage restoration ensures data integrity and complete state recovery.

Furthermore, according to the present invention, by utilizing a transaction queue, the service can continue processing transactions even during restoration, thereby maintaining service continuity. This improves scalability and applicability across the entire multi-cluster environment and, as a result, reduces failure recovery time at the cluster level while maximizing the stability and reliability of the service.

### DESCRIPTION OF DRAWINGS

These and/or other aspects will become apparent and more readily appreciated from the following description of the embodiments, taken in conjunction with the accompanying drawings, in which:

FIG. 1 is a diagram illustrating a cache-based workload migration system in a multi-cluster environment according to an embodiment of the present invention.

FIG. 2 is a diagram illustrating a workload migration process according to an embodiment of the present invention.

FIG. 3 is a diagram illustrating a scenario before the occurrence of a failure situation according to an embodiment of the present invention.

FIGS. 4 to 5 are diagrams illustrating a restoration process when a cluster-level failure occurs according to an embodiment of the present invention.

FIGS. 6 to 7 are diagrams illustrating a two-stage restoration process when a workload-level failure occurs within a cluster according to an embodiment of the present invention.

### DETAILED DESCRIPTION OF EMBODIMENTS

The present invention may be modified in various ways and may have several embodiments. Certain embodiments are illustrated in the drawings and will be described in detail in the specification. However, this is not intended to limit the present invention to specific embodiments, and it should be understood to include all modifications, equivalents, and alternatives that fall within the spirit and scope of the invention.

The terminology used in this specification is for the purpose of describing particular embodiments only and is not intended to limit the invention. The singular forms used herein are intended to include the plural forms as well, unless the context clearly indicates otherwise. In this specification, terms such as “comprise” or “have” are intended to specify the presence of stated features, numbers, steps, operations, components, parts, or combinations thereof but do not preclude the possibility of the presence or addition of one or more other features, numbers, steps, operations, components, parts, or combinations thereof.

In addition, the components of the embodiments described with reference to the accompanying drawings are not limited to the specific embodiments and may be implemented or included in other embodiments within the scope of the technical spirit of the present invention. Furthermore, it is to be understood that, even if not separately described, multiple embodiments may naturally be integrated into a single embodiment.

Also, in the description with reference to the accompanying drawings, the same or corresponding reference numerals are used to denote the same or related components regardless of the figure numbers, and redundant descriptions thereof will be omitted. In the description of the present invention, detailed explanations of known technologies related to the invention will be omitted when it is deemed that such details would unnecessarily obscure the gist of the invention.

The present embodiment proposes a rapid workload migration method to another cluster in a multi-cluster environment to prepare for network failures or performance degradation caused by resource shortages that may occur while operating microservices in one cluster. The workload migration according to this embodiment can be defined as cache-based backup and restoration.

The workload migration method of the present embodiment comprises a first-stage restoration that performs initial infrastructure-level restoration by leveraging the fast accessibility and high processing speed of cache through saving service checkpoints in advance and quickly reading the checkpoint data from the cache, and a second-stage restoration that ensures complete data integrity through Kubernetes resource backup and restoration using external storage.

The first-stage restoration according to the present embodiment rapidly restores the service state, minimizing system downtime and enabling immediate transaction acceptance.

The second-stage restoration temporarily stores transactions flowing in through a transaction queue, thereby guaranteeing service continuity after the first-stage restoration.

The transaction queue is used to prevent conflicts with the second-stage restoration, and once the final restoration is completed, the transactions stored in the queue are sequentially processed to achieve full service restoration. Through this mechanism, the present embodiment minimizes service downtime while achieving fast and stable workload restoration.

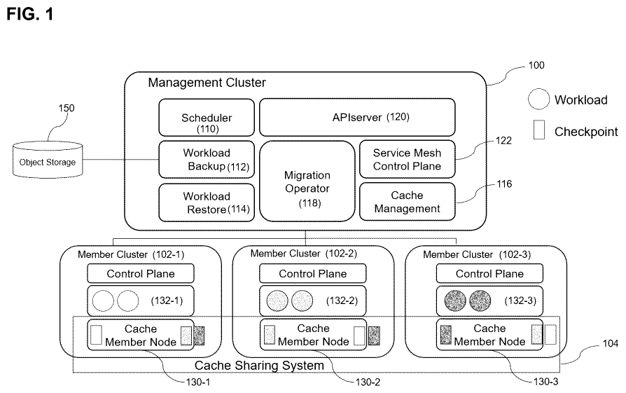

FIG. 1 is a diagram illustrating a cache-based workload migration system in a multi-cluster environment according to the present embodiment.

Referring to FIG. 1, the system according to the present embodiment may comprise a management cluster 100 and a plurality of member clusters 102-1 to 102-3 (collectively referred to as “102”).

The management cluster 100 is built on the control plane within the cloud, performs application deployment to the plurality of member clusters 102, and integrally manages the plurality of member clusters 102 that operate the workloads.

The scheduler 110 of the management cluster 100 manages the states of the plurality of member clusters 102 and performs workload scheduling at the cluster level.

The workload backup controller 112 is a component that automates and manages the process of backing up cluster resources in a Kubernetes environment and transmitting the backed-up data to external storage 150. It performs periodic backups of workloads running in the plurality of member clusters 102.

The workload restore controller 114 is a component that restores resources in a cluster to their original state or to a new cluster using the backed-up data in the Kubernetes environment.

The workload restore controller 114 performs restoration for workloads operated in each member cluster 102 after backup.

The plurality of member clusters 102 according to the present embodiment are provided with a cache sharing system 104 that performs cache-related collection, backup, and restoration functions.

The cache-related collection, backup, and restoration functions of the cache sharing system 104 are performed by cache member nodes 130 provided in each member cluster 102.

The management cluster 100 comprises cache management 116, which manages the plurality of cache member nodes 130.

In addition, the management cluster 100 comprises a migration operator 118 that manages workload restoration according to the present embodiment.

The migration operator 118 is defined as a component that automates workload migration tasks between clusters and guarantees data consistency and service continuity.

The APIserver 120 is a REST endpoint that communicates with all other components and serves as a central hub for communication between the cluster administrator and various components as a core element of the control plane.

The APIserver 120 provides APIs for multi-cluster management and stores and manages state information of the member clusters 102.

The service mesh control plane 122 generates and applies routing rules for traffic management, tracks and manages the locations and statuses of services through service discovery, and manages configurations for proxy sidecars of each service. It also delivers necessary configuration information to maintain consistent operational control across the entire service mesh.

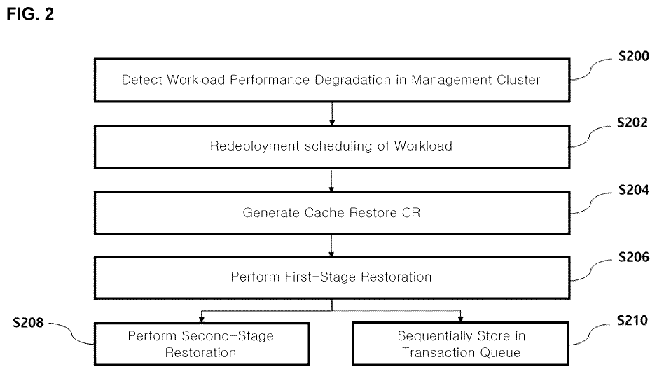

FIG. 2 is a diagram illustrating a workload migration process according to the present embodiment.

Referring to FIG. 2, when a network failure or performance degradation due to lack of resources occurs while operating a microservice workload deployed in a cluster, the management cluster 100 detects the event (step 200).

Subsequently, it performs workload migration depending on whether the failure is at the cluster level or at the workload level within the cluster.

According to whether the failure occurs at the cluster level or the workload level within the cluster, it performs redeployment scheduling of the microservice workloads (step 202).

The migration operator 118 of the management cluster 100 detects the rescheduled microservice workload and generates a cache restore CR (Custom Resource) according to a predefined CRD (Custom Resource Definition) (step 204).

The workload restore controller 114 of the management cluster 100 detects the cache restore CR and periodically reads the checkpoints of the microservice workloads backed up in the cache to perform first-stage restoration on newly created resources (step 206).

The migration operator 118 monitors the progress status of the first-stage restoration, after which the workload restore controller 114 reads the periodically backed-up files from the external storage 150 to perform second-stage resource restoration (step 208).

At the same time, after the first-stage restoration is completed, gradual transaction inflow is allowed, enabling minimum service operation, while transactions are stored sequentially in the transaction queue (step 210). After complete restoration is finished, the transactions are sequentially processed to ensure service continuity. The following describes a scenario before a failure occurs.

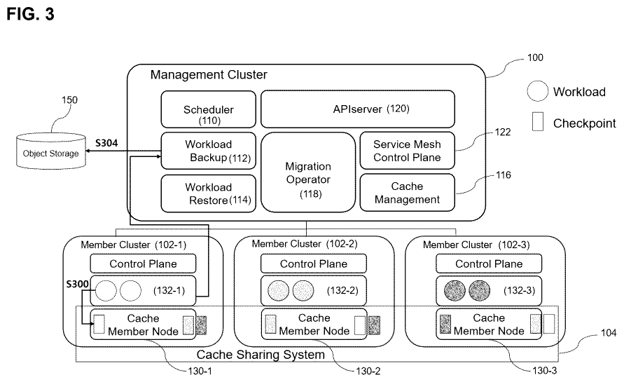

FIG. 3 is a diagram illustrating a scenario before the occurrence of a failure according to the present embodiment.

Referring to FIG. 3, before a cluster failure occurs, workloads are periodically backed up to the external storage 150.

In the member cluster 102, when workloads are deployed to a cluster, a sidecar container 132 is deployed together. The sidecar container 132 periodically generates checkpoints of the workloads and stores them in the cache member node 130 (step 300).

The cache member nodes 130 of each member cluster 102 share data and back up each other's data (step 302).

At the same time, the backup files of workloads generated through the workload backup controller 112 in the management cluster 100 and the checkpoint files generated by the sidecar container 132 are packaged and stored in the external storage 150.

The checkpoints stored in the cache member node 130 are maintained in a previous-and-latest manner, and when a new checkpoint is stored, the oldest checkpoint is deleted to reduce resource usage in the cluster.

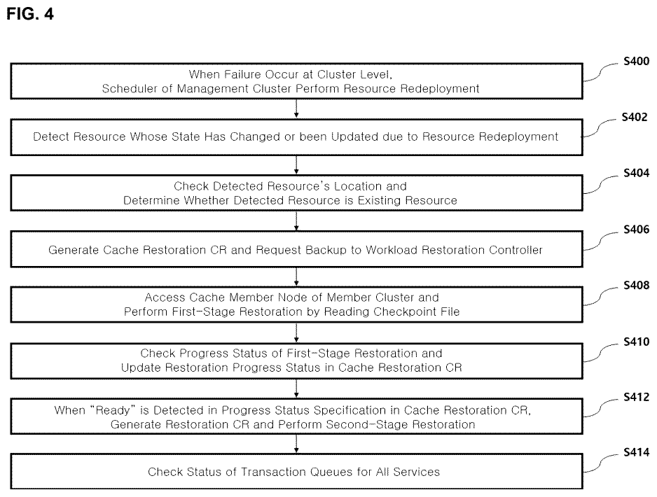

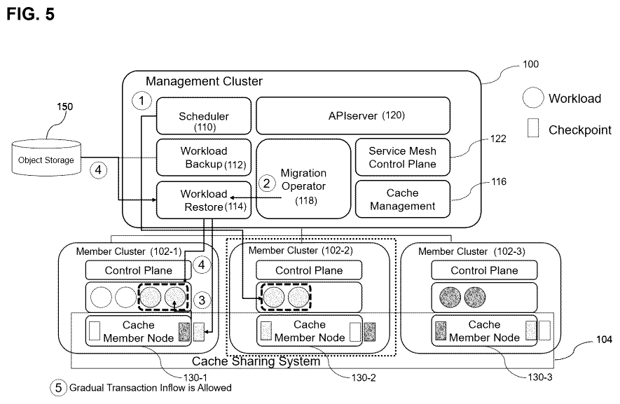

FIGS. 4 to 5 are diagrams illustrating the restoration process when a cluster-level failure occurs according to the present embodiment.

When a failure occurs at the cluster level, the entire cluster experiences problems, causing all workloads under operation to be affected and requiring rapid migration of workloads.

FIG. 4 illustrates the process of migrating workloads deployed in the second member cluster 102-2 to the first member cluster 102-1.

When the management cluster 100, which monitors the state of the member clusters 102, determines that the cluster status is “Fail,” the failover process is triggered in the control plane of the management cluster 100, and the scheduler 110 performs resource redeployment (step 400).

When the scheduler 110 performs resource redeployment, the status of some resources changes or updates. These resources include those that contain cluster state information, resources that record which member cluster 102 the resource was deployed to, resources that determine to which member cluster 102 the resource will be redeployed, and resources that manage the resource templates to be actually deployed to the member cluster 102.

The migration operator 116 detects resources whose status has changed or been updated due to resource redeployment (step 402) and determines whether the detected resource is an existing deployed resource through verification of the resource's location and comparison of its metadata (step 404).

Then, it generates a cache restore CR and requests restoration from the workload restore controller 114 (step 406).

In step 406, the cache restore CR includes information about the target workload to be restored (such as checkpoint location, member cluster ID, and workload metadata).

The workload restore controller 114 detects the cache restore CR and accesses the cache member node 130-1 of the first member cluster 102-1, which is to redeploy the workload, to read the checkpoint file and perform first-stage restoration (step 408).

The migration operator 116 monitors the progress status of the first-stage restoration and updates the restoration progress in the cache restore CR (step 410).

When the migration operator 116 detects “Ready” in the progress status specification of the cache restore CR, it generates a restore CR to trigger second-stage restoration (step 412).

When the workload restore controller 114 detects the restore CR, it retrieves the most recent backup file of the target workload from the external storage 150 and performs restoration (step 412).

In addition, once step 410 is completed and the second-stage restoration begins, gradual transaction inflow is allowed simultaneously.

Step 414 is the process of configuring individual transaction queues for each service using the cache sharing system 104.

Here, the transaction queues are separated by namespaces.

The migration operator 116 integrally monitors the transaction queue status of all services (step 414).

In step 414, when the second-stage restoration of an individual service is completed, the process is automatically triggered (individual trigger) to process the items in the transaction queue. When the latest transaction stored in the transaction queue is processed, the function of the queue is deactivated (individual service), and a restoration status notification is provided.

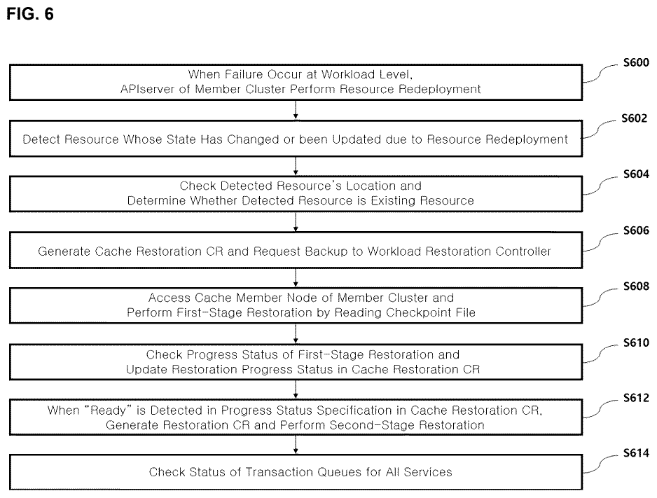

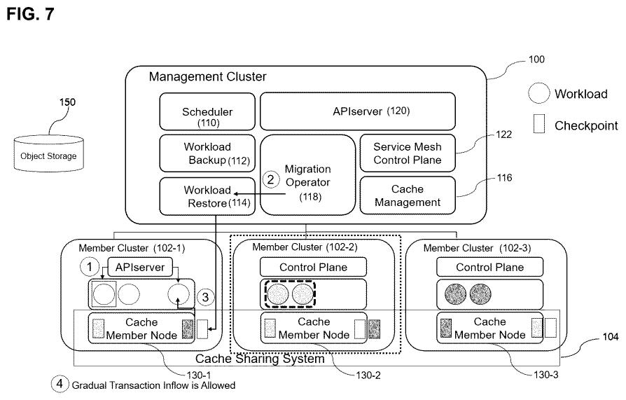

FIGS. 6 to 7 are diagrams illustrating the two-stage restoration process when a workload-level failure occurs within a cluster according to the present embodiment.

When a failure occurs at the workload level within a cluster, the issue lies not in the cluster itself but in a specific workload under operation. This can affect other workloads that are functionally connected to and dependent on the failed workload, causing performance degradation and creating a need for rapid workload migration. The procedure is as follows.

Referring to FIG. 6, since the failure occurs within the cluster, the redeployment scheduling of the target workload that has failed is internally performed by the APIserver of the member cluster (step 600).

The migration operator 116 of the present embodiment detects resources whose status has changed or been updated due to resource redeployment (step 602) and determines whether it is an existing resource through location verification of the created resource and metadata comparison (step 604).

Steps 606 to 614 are identical to steps 406 to 414 in FIG. 4, and thus detailed descriptions thereof are omitted.

The above-described cache-based workload migration method in a multi-cluster environment may also be implemented as a computer-readable medium containing executable instructions such as applications or program modules executed by a computer. The computer-readable medium may be any available medium accessible by a computer and includes both volatile and non-volatile media, as well as removable and non-removable media. In addition, the computer-readable medium may include computer storage media. The computer storage media include both volatile and non-volatile, removable and non-removable media implemented by any method or technology for storing information such as computer-readable instructions, data structures, program modules, or other data.

The embodiments described herein are disclosed for illustrative purposes, and various modifications, changes, and additions can be made by those skilled in the art without departing from the spirit and scope of the invention. Such modifications, changes, and additions should be considered as falling within the scope of the following claims.

1. A cache-based workload migration system in a multi-cluster environment comprising:
a plurality of member clusters operating workloads; and
a management cluster built on a control plane in cloud, configured to deploy workloads to the plurality of member clusters and, when a failure occurs in a first workload of a first member cluster, to perform a first-stage restoration by reading a checkpoint of the first workload backed up in a cache member node of a second member cluster through a migration operator, and to perform a second-stage restoration by retrieving a latest backup file of the first workload stored in an external storage while ensuring gradual inflow of transactions through a transaction queue.

2. The cache-based workload migration system of claim 1 further comprises,
a scheduler configured to perform redeployment scheduling for a failure of the first workload at a cluster level;
a workload backup controller configured to back up resources in the plurality of member clusters to an external storage in a Kubernetes environment; and
a workload restore controller configured to restore resources in the plurality of member clusters to an original state or to a new cluster by using backed-up data in the Kubernetes environment.

3. The cache-based workload migration system of claim 2, wherein the migration operator automates workload migration tasks between clusters and guarantees data consistency and service continuity.

4. The cache-based workload migration system according to claim 3, wherein the migration operator, when a failure occurs in the first workload, generates a cache restore CR (Custom Resource) based on a predefined CRD (Custom Resource Definition), and
the workload restore controller detects the cache restore CR and periodically accesses a cache member node of the second member cluster to read a checkpoint of the first workload and perform a first-stage restoration.

5. The cache-based workload migration system of claim 4, wherein the migration operator performs a second-stage restoration by generating a restore CR when detecting “Ready” in a progress state specification of the cache restore CR.

6. The cache-based workload migration system of claim 5, wherein the workload restore controller, upon detecting the restore CR, reads periodically backed-up files from the external storage to perform a second-stage restoration.

7. The cache-based workload migration system of claim 6, wherein, after completion of the second-stage restoration, transactions stored in the transaction queue are sequentially processed.

8. The cache-based workload migration system of claim 1, wherein the failure includes a network failure or performance degradation caused by lack of resources, and comprises either a cluster-level failure or a workload-level failure within the cluster.

9. A cache-based workload migration apparatus in a multi-cluster environment comprising:
a scheduler configured to manage a state of a plurality of member clusters operating workloads and perform workload scheduling at a cluster level;
a migration operator configured, when a failure occurs in a first workload of a first member cluster among the plurality of member clusters, to perform a first-stage restoration by reading a checkpoint of the first workload backed up in a cache member node of a second member cluster, and to perform a second-stage restoration by retrieving a latest backup file of the first workload stored in an external storage while ensuring gradual inflow of transactions through a transaction queue;
a workload backup controller configured to back up resources in the plurality of member clusters to an external storage in a Kubernetes environment; and
a workload restore controller configured to restore resources in the plurality of member clusters to an original state or to a new cluster by using the backed-up data in the Kubernetes environment.

10. The cache-based workload migration apparatus of claim 9, wherein the migration operator, when a failure occurs in the first workload, generates a cache restore CR (Custom Resource) based on a predefined CRD (Custom Resource Definition), and
the workload restore controller detects the cache restore CR and periodically accesses a cache member node of the second member cluster to read a checkpoint of the first workload and perform a first-stage restoration.

11. The cache-based workload migration apparatus of claim 10, wherein the migration operator performs a second-stage restoration by generating a restore CR when detecting “Ready” in a progress state specification of the cache restore CR.

12. The cache-based workload migration apparatus of claim 11, wherein the workload restore controller, upon detecting the restore CR, reads periodically backed-up files from the external storage to perform a second-stage restoration.

13. The cache-based workload migration apparatus of claim 12, wherein, after completion of the second-stage restoration, transactions stored in the transaction queue are sequentially processed.

14. The cache-based workload migration apparatus of claim 9, wherein the failure includes a network failure or performance degradation caused by lack of resources, and comprises either a cluster-level failure or a workload-level failure within the cluster.

15. A cache-based workload migration method in a multi-cluster environment through a management cluster built on a control plane in cloud comprising:
deploying workloads to a plurality of member clusters;
performing, when a failure occurs in a first workload of a first member cluster among the plurality of member clusters, a first-stage restoration by reading a checkpoint of the first workload backed up in a cache member node of a second member cluster; and
performing a second-stage restoration by retrieving a latest backup file of the first workload stored in an external storage while ensuring gradual inflow of transactions through a transaction queue.
